(19) United States
(12) Patent Application Publication
(10) Pub. No.: US 2021/0387832 A1
(43) Pub. Date: Dec. 16, 2021

(54) DETECTION SYSTEM FOR AN ABNORMAL SITUATION DURING ELEVATOR OPERATION

(71) Applicant: KONE Corporation, Helsinki (FI)

(72) Inventors: Mikko Viljanen, Helsinki (FI); Tarvo Viita-aho, Helsinki (FI); Tapani Talonen, Helsinki (FI); Matti Räsänen, Helsinki (FI); Juha-Matti Aitamurto, Helsinki (FI); Tapio Siironen, Helsinki (FI); Ville Myyryläinen, Helsinki (FI); Henri Wenlin, Helsinki (FI)

(73) Assignee: KONE Corporation, Helsinki (FI)

(21) Appl. No.: 17/246,802

(22) Filed: May 3, 2021

(30) Foreign Application Priority Data
Jun. 16, 2020 (EP) 20180211.3

(51) Int. Cl. B66B 5/06; B66B 5/12

(52) U.S. Cl. CPC B66B 5/06; B66B 5/125

(57) ABSTRACT

The invention concerns a method, system and computer program for monitoring the run of a roping interconnecting a car and a counterweight of an elevator and for detecting an abnormal operation condition during the drive of a traction sheave intending therewith the car and the counterweight to be moved via said roping. Said roping is running on its way from the car to the traction sheave via at least one pulley and on its way from the counterweight to the traction sheave via at least one pulley, wherein the rotation of said at least two pulleys is monitored by sensing their rotation. These rotation data are then analysed in view of a mutual correlation indicating therewith a synchronized run of the roping on either side of the traction sheave, and detecting therewith an abnormal situation when detecting an absence of such correlation.

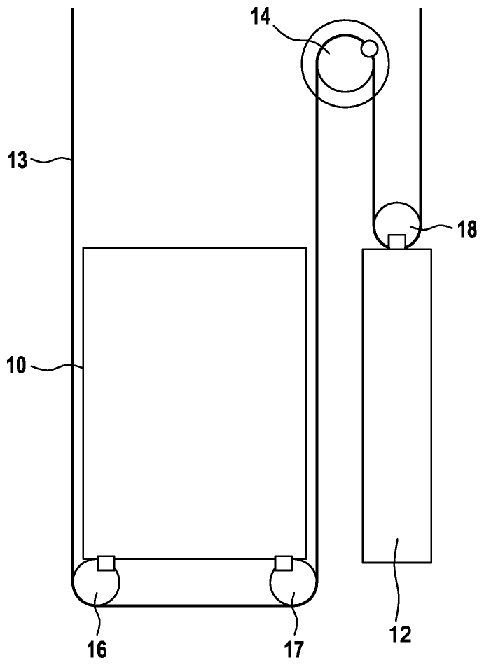

### FIELD OF THE INVENTION

The present invention relates to the field of elevator technology and more particularly to a detection system monitoring an abnormal moving situation for an elevator car and/or a counterweight.

### BACKGROUND OF THE INVENTION

One of the most popular elevator designs is still the roped traction elevator. In current versions of such type having the car linked to a counterweight via a suspension roping, the roping is guided in kind of loop over a traction sheave which is driven by motor force to move the car either up or down. Therewith a movement of the counterweight is linked in opposite direction, meaning that in case the car travels down the counterweight goes up, and vice versa. Said roping can be of a round rope type or a flat belt. As regards the counterweight, it weighs about the same as the empty car filled to 40-percent of its rated capacity. In other words, when the car is 40 percent full (an average amount), the counterweight and the car are perfectly balanced. The purpose of this balance is to conserve energy and ensure adequate friction between the suspension roping and traction sheave. With equal loads on each side of the sheave, it only takes a little bit of force to tip the balance one way or the other. To put it another way, the balance maintains a near constant potential energy level in the system as a whole. The friction between this roping and the traction sheave is critical in elevators. In normal operation conditions the friction between the ropes and the traction sheave is large enough so that when the motor operates the traction sheave the elevator moves up or down in a predictable and reliable way.

A special abnormal situation can occur in case either the car or the counterweight gets jammed during its downward moving action, respectively. Such a situation for example can occur as a result of a guide shoe failure. This is called “stalling”. If the friction between the suspension ropes and traction sheave is high enough, slack rope will accumulate above the jammed corpus. This is caused by the further rotation of the traction sheave being in operation to lift the requested route of the corpus being on the other side of the traction sheave. Such slackening of the suspension roping can cause inconveniences or even a safety risk: For example, losing traction after a while during which loose rope has accumulated to the counterweight side results in the elevator car going into free fall which is abruptly terminated either by the suspension rope tightening on the loose side or the elevator overspeed governor and safety gear stopping the car—the former exerting an extraordinary load in the suspension ropes and both being very inconvenient or even dangerous to passengers in the car. A further example of stalling is a situation where the counterweight or the elevator car runs downward onto its buffer at the bottom of the hoistway, respectively, while the hoisting machine continues to lift the opposite side—resulting in the corpus at the opposite side crashing to the ceiling of the hoistway. To sum up, “stalling” is a situation in which a counterweight or an elevator car does not move down all the way which way, however, should be aimed at based on the rotation of the hoisting machine. This situation shall be accompanied by stopping the elevator as early as possible after detecting such stall condition.

In prior art, the detection of the stall condition is based on monitoring either the current demand of the hoisting machine of the traction sheave or the torque generated by the hoisting machine of the elevator. To this end, EP 2 865 629 B1 of the same applicant reveals such a solution. When a rapid change in the torque is detected a stalling condition is suspected. A disadvantage with these solutions is, however, that an indirect threshold value is needed to characterize a situation to be an abnormal one. Irrespective of whether the stalling situation shall be recognized by the current of the motor or by its torque, both these parameters do have values also during a normal operation situation. Therefore, said threshold must be defined in its value amount to characterize a situation being outside such normal range.

The object of the present invention is thus to show a direct and more reliable way and system for monitoring the roping of an elevator and for detecting a stalling situation.

### SUMMARY OF THE INVENTION

The above object is achieved by a method according to claim 1, a computer program according to claim 4, and a system according to claim 5. Advantageous embodiments are disclosed in the respective subclaims, respectively.

Basic idea of the invention is a monitoring and a detection of a stalling situation by sensing the run of at least two pulleys by which the suspension roping is guided in the hoistway, one of which pulleys being located at the elevator car and one being not positioned in reference with the car. The one not belonging to the car can be the sheave as the driving pulley or a pulley located at the counterweight. A pulley at the car by which the suspension roping runs ought to rotate at the same peripheral speed as any other pulley by which the suspension roping runs The monitored pulleys are equipped with a sensing system sensing their rotation, respectively. When receiving these sensing data from the pulley sensors at the car and counterweight, it is possible to evaluate the run of the roping on both sides of the traction sheave in that the runs are compared to one another. Such running data of the pulleys do mean an information whether the compared pulleys have transported the same length of the rope over those distances that indicate a correct travel of both the car and the counterweight. As soon as there is a difference recognized between these rotation-data of the pulleys, an extraordinary situation can be suspected. It can be calculated in dependence of the characteristics of the respective pulleys whether or not there is a difference in the rotation of the pulleys equipped with the sensors. The sensing system in a convenient manner comprises a velocity sensor, such as an encoder, which transmits velocity data to a control unit that handles said data. From them various other information can be then gained like the rotation distance a pulley has accomplished over time, provided the dimension data of the pulley are stored in a memory of the control unit.

Additionally, such analysis can be augmented by including the data of the rotation of the traction sheave itself or by the data of the machine that drives the traction sheave. Such data can include the rotational speed of the traction sheave, its power consumption or its torque.

When the elevator is running for moving either the car or the counterweight in up or down direction with commands from the drive, the movement of the car and counterweight can be determined by the output of the sensing system in the pulleys of the car and counterweight. Since the meant pulleys are moving at the same time when the elevator is running, their rotation-data can be used to monitor a stalling. If one of the pulleys stop moving or decelerate moving while the other one continues to move, it is an indication of a stalling situation.

As an alternative, a limit value can be set indicating a maximum allowed speed difference so that as soon as said speed difference limit is exceeded an emergency situation can be defined with and a stop can be triggered for the elevator. Therewith, the elevator drive can be disabled by switching the elevator on a fault mode.

By means of that, there is the benefit according to the invention that a stalling situation can be identified by the movement of the car and the counterweight independently from each other and independently from the run of the hoisting machine. In other words, the benefit of the invention is that it is capable of detecting a stalling condition in situations that are not covered at all by the conventional methods, such as implementing a torque or current threshold by one single entity, namely the traction sheave of the motor.

Furthermore, when the stalling condition controlling is handled according to the invention the designer for the elevator has more freedom in view of choosing friction properties for the ropes and the traction sheave. This may even allow a better functionality.

A further benefit of the invention is that it provides a better passenger security. When the elevator car starts stuttering, meaning a temporary stopping over a short time due to an undesired defect, the car will start falling freely a short distance until the slackening of the rope is eliminated and the rope is taut again. This means inevitably an impact for the passengers which impact is not only uncomfortable but may be also dangerous. By means of the invention the stalling situation is detected much more quickly so that the elevator may be stopped before a risky rope-slacking occurs. Therewith, risks or inconveniences for the passengers in the elevator car are prevented. Correspondingly a stall condition of the counterweight may cause risks or inconveniences.

The present invention is applicable in all elevators in which there is a risk of pulling the elevator car or counterweight upwards independently of the other part. It is further applicable for all elevators having a traction sheave involving suspension means including common twisted cord steel ropes, high friction coated ropes, cogged belts and similar. The elevator may be stopped or an alarm may be launched when the stalling condition is suspected.

According to the present invention there are the following options for an implementation of how a running speed monitoring for the suspension roping can be accomplished:

Measuring the rotation speed of one or more

diverter pulley(s)

roller guide shoes or

in sheaves of an overspeed governor on the car side of the suspension roping by means of a sensor, and measuring the rotation speed of one or more

diverter pulley(s)

roller guide shoes or

in sheaves of an overspeed governor on the counterweight side of the suspension roping by means of a sensor.

Further, a motor encoder sensor that is measuring the rotation speed of the traction sheave can be additionally implemented to include this speed still further for comparison of the speeds.

Apropos, the above explained diverter pulley and traction sheave speed difference detection can work in parallel with a slack rope detection system being present in rope terminals as such a system is for example shown in document WO 2007/144456. In such a system, a detector is used that senses a tensile stress in the rope. The most feasible system can then be for the detection of a counterweight stuck being detected with a slack rope detection on the counterweight side terminal and a car stuck being detected by a speed difference between the car pulley and the traction sheave.

### BRIEF DESCRIPTION OF THE DRAWINGS

The FIGURE illustrates the elevator system according to the invention.

### DETAILED DESCRIPTION OF THE PREFERRED EMBODIMENTS

The invention is now described in more detail by taking reference to the enclosed drawing. Therein, The FIGURE shows the inventive concept. The elevator system shown includes an elevator car 10 being suspended by a roping 13 which roping is guided over a traction sheave 14 to reach and suspend the counterweight 12. The roping is guided over pulley1 16, pulley2 17 both belonging to the elevator car, while there is a further pulley3 18 belonging to the counterweight. As soon as the roping is moving for raising or lowering the car, there is inherently a rotation of each of the pulleys 16, 17, 18 that is linked to such movement. This means that each pulley 16, 17, 18 is showing a characteristic angle-distance running over as soon as the roping travels over the pulleys, respectively. In other words, there is a velocity v1 for pulley1 16, there is a velocity v2 for pulley2 17 and there is a velocity v3 for pulley3 18. Although being dependent from the size of the respective pulley there can be nevertheless a comparison between all these running-values with each other so that in a normal operation specific data must be provided from each pulley to know about a correct run of the roping. This means that, in case all pulleys, i.e. pulley1, pulley2 and pulley3 are of the same size, there must be the same velocity and the same rotational angle-distance for all of them as long as the elevator is running correctly. As soon as a match between the speeds of the pulleys or the rotated distances, respectively, can no longer be determined, a stalling situation can be identified that indicates that either the car or counterweight is not advancing freely.

Therewith, an emergency situation can be triggered by starting an alarm or even by stopping the run of the elevator.

At least, the rotation of the traction sheave 14 can be included into the comparison-process by adding its torque or the energy consumption by means of the current needed to evaluate whether a normal operation is present or not.

Reference Numerals:

10 elevator car

12 counterweight

13 roping

14 traction sheave

16 pulley1

17 pulley2

18 pulley3

1. A method for monitoring the run of a roping interconnecting a car and a counterweight of an elevator and for detecting an abnormal operation condition during the drive of a drive pulley intending therewith the car and the counterweight to be moved by said roping, wherein the roping runs from the car to the drive pulley via at least one diverting pulley and from the counterweight to the traction drive pulley via at least one diverting pulley, said method comprising the steps of:
monitoring the rotation of at least two of said pulleys by sensing rotation thereof; and
analysing rotation data in view of a mutual correlation indicating unobstructed advancing of the car or counterweight or both, and detecting therewith an abnormal situation when detecting an absence of such correlation.

2. The method according to claim 1,
wherein a stopping of the run of the elevator is initiated as a response of an abnormal difference in the mutual rotation data.

3. The method according to claim 1,
further comprises further comprising the step of launching an alarm as a response to a detected abnormal operation condition.

4. A computer program comprising a program code embodied on a non-transitory computer readable medium and adapted to cause the method according to claim 1 to be executed on a data-processing system.

5. A system for monitoring the run of a roping interconnecting a car and a counterweight of an elevator and for detecting an abnormal operation condition during the drive of a drive pulley intending therewith the car and the counterweight to be moved by said roping, the system comprising:
at least one diverting pulley coupled to the car, the drive pulley and at least one diverting pulley coupled to the counterweight, wherein the at least two pulleys are equipped with sensors sensing rotation thereof, respectively; and
a control unit configured to receive the sensor data and to analyse the sensor data by monitoring a mutual correlation indicating therewith unobstructed advancing of the car or counterweight or both.

6. The system according to claim 5,
wherein the system is configured to stop the run of the elevator as a response of the detection of an abnormal difference in the mutual correlation.

7. The system according to claim 5,
wherein the system is configured to launch an alarm as a response to a detected abnormal difference in the mutual correlation.

8. The method according to claim 2,
further comprising launching an alarm as a response to a detected abnormal operation condition.

9. A computer program comprising a program code embodied on a non-transitory computer readable medium and adapted to cause the method according to claim 2 to be executed on a data-processing system.

10. A computer program comprising a program code embodied on a non-transitory computer readable medium and adapted to cause the method according to claim 3 to be executed on a data-processing system.

11. The system according to claim 6,
wherein the system is configured to launch an alarm as a response to a detected abnormal difference in the mutual correlation.
